(19) United States
(12) Patent Application Publication
(10) Pub. No.: US 2015/0293523 A1
(43) Pub. Date: Oct. 15, 2015

(54) MACHINE TOOL DIAGNOSTIC METHOD AND SYSTEM

(71) Applicant: MITSUBISHI HEAVY INDUSTRIES, LTD., Tokyo (JP)

(72) Inventors: Hideaki YAMAMOTO, Tokyo (JP); Yasuo FUJISHIMA, Tokyo (JP)

(73) Assignee: MITSUBISHI HEAVY INDUSTRIES, LTD., Tokyo (JP)

(21) Appl. No.: 14/685,205

(22) Filed: Apr. 13, 2015

(30) Foreign Application Priority Data
Apr. 15, 2014 (JP) 2014-083884

(51) Int. Cl. G05B 19/4065; G06N 99/00

(52) U.S. Cl. CPC G05B 19/4065; G06N 99/005

(57) ABSTRACT

A machine tool diagnostic method includes: an initial acquisition step for acquiring initial measurement data by measuring multiple parameters of the machine tool while operating the machine tool in a predetermined operating pattern; a generating step for generating a normal area in a mapping space of a 1 class support vector machine method using the initial measurement data as training data; a reacquisition step in which, after operating the machine tool, the multiple parameters are measured to acquire re-measured data while again operating the machine tool in the predetermined operating pattern; and a diagnostic step for diagnosing the machine tool using the re-measured data as test data, based on whether or not the test data is contained in the normal area of the mapping space in the 1 class support vector machine method.

### BACKGROUND OF THE INVENTION

1. Field of the Invention

The present invention pertains to a machine tool diagnostic method and system, and more particularly to a diagnostic method and system for diagnosing machine tools using a 1 class support vector machine (SVM).

2. Description of Related Art

Machine tools experience time-related changes and mechanical damage such as wear and degradation with use. For this reason, regular inspections and part replacements were performed with the object of preventing sudden malfunctions or stoppage of the machine tool. However, once an anomaly such as an abnormal stoppage or irregular sound occurs on a machine tool, there is a need to ascertain the cause, to obtain or fabricate replacement parts, or even to perform corrective construction, thereby lengthening machine tool downtime. Therefore various technology has been proposed, as disclosed in Patent Document 1 (Japanese Unexamined Patent Application Publication No. 2013-164386), Patent Document 2 (Japanese Unexamined Patent Application Publication No. 2008-97363) and Patent Document 3 (Japanese Patent No. 4434350), to automatically diagnose abnormal conditions before an abnormal stoppage or the like occurs in a machine tool.

Patent Documents 1-3 disclose technology for diagnosing abnormalities in a machine tool by comparing the values of output signals from sensors such as accelerometers installed on a machine tool with predetermined threshold values. Methods have also been proposed which utilize multiple sensor output signals, but basically the presence or absence of a fault is diagnosed by comparing the numerical values of sensor output signals or analytic results such as frequency analysis values with predetermined threshold values.

It happens that when diagnosing a machine tool, a more comprehensive diagnosis may be possible using output signal values for multiple parameters rather than a single parameter of the machine tool.

When performing a diagnosis using multiple parameters one can conceive, for example, of using the Mahalanobis method used in multivariate statistical analysis. In the Mahalanobis method, a unit space is set within a reference Mahalanobis distance from the center of the distribution of a sample data set, taking into account the correlation with sample data parameters, and a determination is made as to whether the Mahalanobis distance for the measured data is contained in this unit space. A diagnosis of normal is then made when the Mahalanobis distance for the target data is contained in the unit space, and a diagnosis of abnormal is made when it is not contained therein.

However, in a mapping space in the Mahalanobis method, there is only one unit space determined to be normal. Therefore when a sample data set is divided into multiple clusters, even abnormal data between clusters ends up being contained inside the unit space.

As a result, in the Mahalanobis method there is a potential that abnormal data will be misdiagnosed as normal.

### BRIEF SUMMARY OF THE INVENTION

### Technical Problem

The present invention therefore has the object of providing a diagnostic method and diagnosis system capable of implementing a high accuracy diagnosis of a machine tool.

### Solution to Problem

To achieve the above objective, the machine tool diagnostic method of the first invention includes: an initial acquisition step for acquiring initial measurement data by measuring multiple parameters of the machine tool while operating the machine tool in a predetermined operating pattern;

a generating step for generating a normal area in a mapping space of a 1 class support vector machine method using the initial measurement data as training data;

a reacquisition step in which, after operating the machine tool, the multiple machine tool parameters are measured to acquire re-measured data while again operating the machine tool in the predetermined operating pattern; and

a diagnostic step for diagnosing the machine tool using the re-measured data as test data, based on whether or not the test data is contained in the normal area of the mapping space in the 1 class support vector machine method.

In the invention thus constituted, a machine tool diagnosis is performed using machine learning pattern recognition (correlations between multiple data), based on the 1 class SVM method. In the 1 class SVM method, multiple complex areas can be generated as normal areas. Therefore a higher level of diagnostic accuracy can be achieved than when using the Mahalanobis method, with which only a single area of an elliptical area can be generated as unit space.

Also, in the present invention initial data, which measures multiple parameters while operating a machine tool in predetermined operating pattern[s], is used as training data, and re-measured data, which measures multiple parameters while operating in the same predetermined patterns, is used as test data. A higher accuracy diagnostic can thus be achieved.

Also, because the machine tool is generally an expensive item, purposely breaking several machine tools to acquire abnormality data is not realistic. Therefore in the present invention support vector machine (SVM) training (machine learning) is implemented using a 1 class method, which utilizes initial measurement data, i.e., normal data only, as training data. Hence in the present invention there is no need to acquire abnormal data prior to diagnosing.

The machine tool diagnostic method of the present invention therefore enables a high accuracy machine tool diagnosis to be achieved.

Also, in the present invention the diagnostic step preferably diagnoses the machine tool as normal when the test data is contained in the normal area, and diagnoses the machine tool as abnormal when the test data is not contained in the normal area.

Thus using the 1 class SVM method, high accuracy diagnosis of a normal/abnormal machine tool state can be achieved.

Also, in the present invention the predetermined operating pattern is preferably an operating pattern in which the machine tool machines a workpiece, and the diagnostic step diagnoses the machining of the workpiece by the machine tool as normal machining when the test data is contained in the normal area, and diagnoses the machining of the workpiece by the machine tool as defective machining when the test data is not contained in the normal area.

The machine tool is operated by the same operating pattern when machining mass produced workpieces such as cogs or gears. Thus by generating, as training data, a normal area in a 1 class support vector machine method mapping space using initial measurement data, measured while operating the machine tool under the operating pattern used when machining a workpiece, re-measured data from when the machine tool is actually machining a workpiece can be utilized as test data. If there is an abnormality in the machine tool at that point, the machining precision of the workpieces machined by the machine tool will decrease, degrading the quality of workpieces. Therefore a good/bad diagnosis of the machining of a workpiece can be made based on data from operating patterns at the time of machining. As a result, a good/bad diagnosis of workpiece machining, e.g., checking of workpiece machining precision or quality, can be made based on data measured when the workpieces are machined.

Also, in the present invention the reacquisition step is preferably performed multiple times at different periods, and the diagnosis step predicts timing of a deviation in test data from the normal area as timing of a machine tool failure occurrence, based on changes over time in the position of the test data in the mapping space.

Thus using shifts over time in diagnostic results, the timing of a test data deviation from the normal area can be predicted as the timing for a machine tool failure.

Also, in the present invention the reacquisition step is preferably performed multiple times at different periods, and the diagnosis step predicts timing of a deviation in test data from the normal area as timing for replacing consumable parts built into the machine tool, based on changes over time in the position of the test data in the mapping space.

Thus based on time changes in diagnostic results, a lifespan prediction can be made of the timing for a deviation of test data from the normal area as the replacement timing for consumable parts built into the machine tool, such as bites or other cutting tools, or sharpening stones, etc.

Also, the present invention preferably further includes a step for generating a new normal area in a new mapping space of the 1 class SVM method using the test data as additional training data, the diagnostic step diagnoses that the machine tool is abnormal when the test data is not contained in the new normal area, and the diagnostic step diagnoses that, even when the test data is contained in the new normal area, the machine tool is degraded by aging if the test data is not contained in the initial normal area, and the diagnostic step diagnoses that the machine tool is normal when the test data is contained in both the new normal area and the initial normal area.

The characteristics of machines, including machine tools, generally change over time. These time-related changes in characteristics do not necessarily result in machine abnormalities; in fact the machine is often in a more stable operating state than at time of shipment. Therefore if diagnosing based only on initial training data, there is a risk that diagnostic accuracy will gradually decrease. Decreases in diagnostic accuracy can be prevented by updating the 1 class SVM method mapping space normal area using test data as additional training data, so as to diagnose machine tool aging degradation separately from fault diagnosis.

In order to achieve the aforementioned object, a machine tool diagnostic system pertaining to a second invention includes: a measurement unit for outputting initial measurement data by measuring multiple parameters of the machine tool while operating the machine tool in a predetermined operating pattern, wherein, after the operation of the machine tool, the measurement unit outputs re-measured data by measuring the multiple parameters of the machine tool while operating the machine tool in the predetermined operating pattern again; a training unit for generating a normal area in a mapping space of a 1 class support vector machine method using the initial measurement data as training data; a storage unit for storing the normal area in the mapping space; and a diagnostic unit for diagnosing the machine tool based on whether or not the test data is contained in the normal area in the mapping space of the 1 class support vector machine method mapping space, by using the re-measured data as test data.

In the invention thus constituted, a machine tool diagnosis is performed using machine learning pattern recognition (correlations between multiple data), based on the 1 class SVM method. Also, in the present invention initial data, which measures multiple parameters made while operating the machine tool in predetermined operating patterns, is used as training data, and re-measured data, which measures multiple parameters while operating in the same predetermined patterns, is used as test data. Thus by using the machine tool diagnostic system of the second invention, a high accuracy machine tool diagnosis can be achieved, as with the first invention.

Also, in the present invention the diagnostic unit preferably diagnoses the machine tool as normal when the test data is contained in the normal area, and diagnoses the machine tool as abnormal when the test data is not contained in the normal area.

Thus in the second invention, as in the first invention, a high accuracy diagnosis of machine tool normality/abnormality can be achieved by the 1 class SVM method.

Also, in the present invention the predetermined operating pattern is preferably an operating pattern by which the machine tool machines a workpiece, and the diagnostic unit diagnoses the machining of the workpiece by the machine tool as normal machining when the test data is contained in the normal area, and diagnoses the machining of the workpiece by the machine tool as defective machining when the test data is not contained in the normal area.

Hence the second invention, as in the first invention, can diagnose good/bad workpiece machining based on data from the time the workpiece was machined.

Also, in the present invention the measurement unit preferably measures the re-measured data at multiple different times, and the diagnosis unit predicts timing of a deviation in test data from the normal area as timing of a machine tool failure occurrence, based on changes over time in the position of the test data in the mapping space.

Thus in the second invention, as in the first invention, the timing of a test data deviation from the normal area can be predicted as the timing for a machine tool failure using time-related changes in diagnostic results.

Also, in the present invention the measurement unit preferably measures the re-measured data at multiple different times, and the diagnosis unit predicts timing of a deviation in test data from the normal area as timing for replacement of consumable parts bunt into the machine tool, based on changes over time in the position of the test data in the mapping space.

Thus in the second invention, as in the first invention, a lifespan prediction can be made of the timing for replacement of consumable parts built into the machine tool using time-related changes in diagnostic results.

Also, in the present invention the training unit preferably uses the test data as additional training data to generate a new normal area in a new mapping space in the 1 class support vector machine method, and the storage unit stores the new normal area in the mapping space, and the diagnostic unit diagnoses a machine tool as abnormal when the test data is not contained in the new normal area, and even when the test data is contained in the new normal area, diagnoses that the machine tool is degraded by aging when the test data is not contained in the initial normal area, and diagnoses that the machine tool is normal when the test data is contained in both the new normal area and the initial normal area.

Thus in the second invention, as in the first invention, decreases in diagnostic accuracy can be prevented by updating the 1 class SVM method mapping space normal area using test data as additional training data, so as to diagnose machine tool aging degradation separately from fault diagnosis.

Therefore a high accuracy machine tool diagnostic method and system can be achieved using the machine tool diagnostic method of the present invention.

### BRIEF DESCRIPTION OF THE SEVERAL VIEWS OF THE DRAWINGS

FIG. 1 is a diagram explaining a machine tool diagnostic system according to an embodiment of the invention.

FIGS. 2(a) through 2(e) are schematic diagrams of predetermined operating patterns.

FIG. 3 is a schematic diagram of normal data in a 1 class SVM method mapping space.

FIG. 4 is a block diagram explaining the diagnostic flow using the 1 class SVM method in a first embodiment.

FIG. 5 is a block diagram explaining the diagnostic flow using the 1 class SVM method in a second embodiment.

FIG. 6 is an explanatory diagram of fault timing prediction based on the diagnostic results in a third embodiment.

FIG. 7 is an explanatory diagram of a replacement timing prediction based on the diagnostic results in a fourth embodiment.

FIG. 8 is a block diagram explaining a diagnostic flow using the 1 class SVM method in a fifth embodiment.

### DETAILED DESCRIPTION OF THE INVENTION

Below ing to the attached figures, we explain embodiments of the machine tool diagnostic method and system of the present invention.

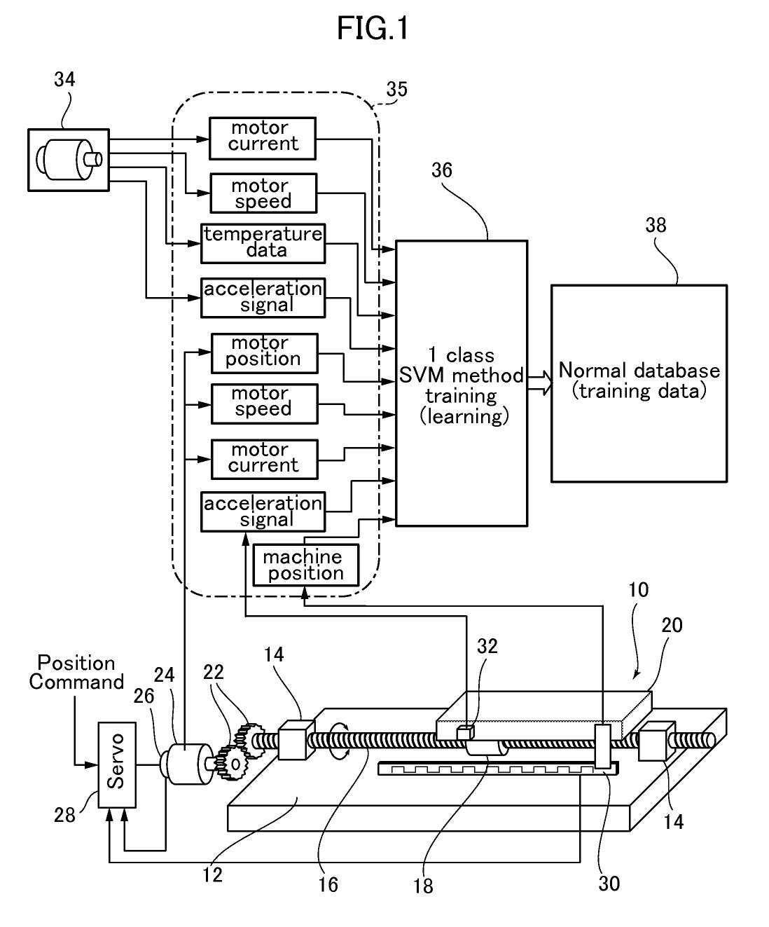

FIG. 1 is an explanatory diagram of a machine tool diagnostic system common to all of the embodiments.

FIG. 1 primarily shows primarily the feed system in machine tool 10.

The ball screw on the feed system of machine tool 10 comprises a ball screw threaded portion 16, supported to rotate freely on support bearings 14 placed within bracket 14 affixed to head 12, and a ball screw nut portion 18, threaded onto ball screw threaded portion 16.

Table 20 is attached to ball screw nut portion 18. A position detector 30 and acceleration sensor 32 are attached to table 20. The rotational force of servo motor 24 is transferred through speed reduction gear 22 to ball screw threaded portion 16. The rotation of servo motor 24 is controlled by a servo control device 28. A position command signal from a numerical control device (not shown) is input into servo control device 28, as is a table position feedback signal and a speed reduction feedback signal from pulse coder 26.

In the present embodiment, multiple machine tool parameters are measured to acquire initial measurement data 35. In the example shown in FIG. 1, the motor position, motor speed, and motor current of servo motor 24 are measured. Mechanical position and acceleration signals for table 20 are output from table position detector 30 and acceleration sensor 32. Also, in addition to the feed system, motor current, motor speed, temperature data, and an acceleration signal for main shaft motor 34 are output from sensors not shown.

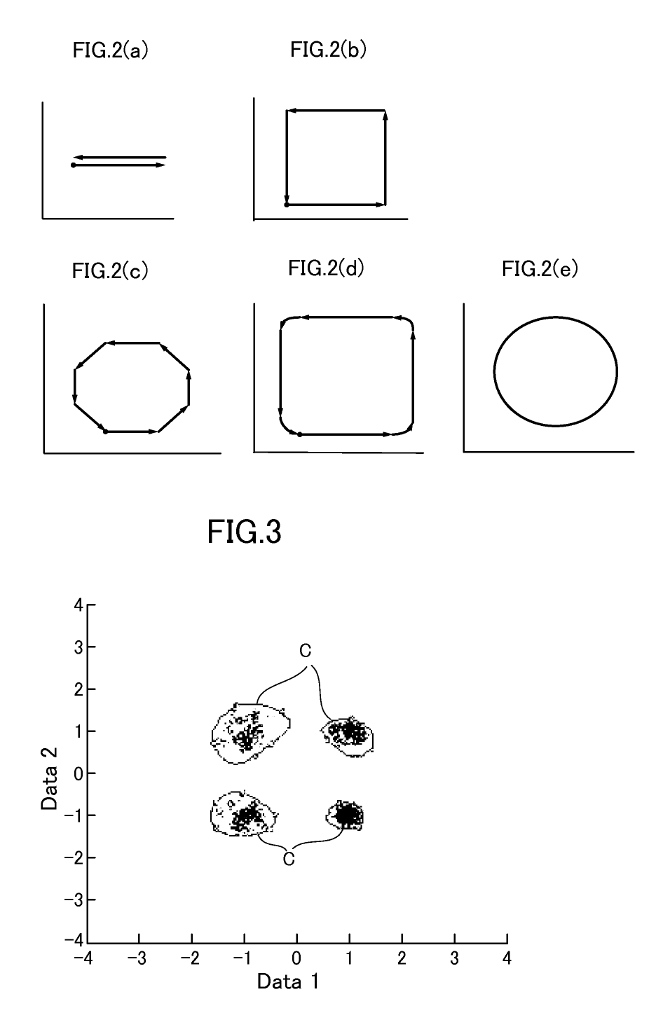

This initial measurement data 35 is measured as machine tool 10 is being operated in predetermined operating patterns. Here we show an example of the FIG. 2 operating pattern. FIGS. 2(a) through (e) respectively show motion patterns for a return trip motion, motion along a square, motion along an octagon, motion along a rectangle with curved corners, and a circular motion.

Note that the motion patterns shown in FIGS. 2(e) through (e) are all motions within a 2D plane, but motion patterns in a 3D space may also be employed.

Next, the training unit uses initial data measured at the time of a predetermined operating pattern as training data to generate a normal area in a 1 class support vector machine method mapping space (feature space).

Initial measurement data 35 is the normal data when machine tool 10 is shipped. In the 1 class SVM method, machine learning can be conducted in which only machine tool initial data at a normal time, i.e., normal data, is used as training data. Hence there is no need to break the machine tool to acquire abnormal data.

In this embodiment, training is conducted by concurrent use of a kernel method in 1 class SVM.

Kernel κ is the inner product of data in the feature space; the design and parameter settings of this kernel are items which determine the accuracy of pattern recognition. In 1 class SVM, it is in practice sufficient to determine only Gaussian kernel parameters.

When using a Gaussian kernel is used, the following equation obtains: (σ²>0 is a kernel parameter to be set by the designer).

$$κ ( x , z ) = exp ( \frac{{‖ x - z ‖}^{2}}{{σ}^{2}} ) \qquad ( Eq . 1 )$$

In the 1 class SVM method, optimum parameter α=[α₁,α₂, . . . αₘ] are obtained for the following evaluation function:

$${min}_{α} \frac{1}{2} {\sum }_{i , j} {α}_{i} {α}_{j} κ ( {x}_{i} , {x}_{j} ) \\ subject to 0 \leq {α}_{i} \leq \frac{1}{v l} , {\sum }_{i = 1}^{l} {α}_{i} = 1 \qquad ( Eq . 2 )$$

Here xᵢ is training data. Also, 1≧v>0 is one parameter; it is a soft margin which can be freely set by the designer. A soft margin is the upper limit of the proportion of training data viewed as missed values; for example, if set to 0.1, a max mum of 10% of the total data will be viewed as missed values. Also, αᵢ is closely related to xᵢ, and xᵢ's for which αᵢ>0 are called support vectors. Using a obtained through training completes an SVM discriminator expressed by the following equation:

$$f ( x ) = sgn ( {\sum }_{i = 1}^{l} {α}_{i} κ ( {x}_{i} , x ) - {\sum }_{i = 1}^{l} {α}_{i} κ ( {x}_{i} , {x}_{s v} ) ) \qquad ( Eq . 3 )$$

Here sgn(a) is a signum function; when a≧0, i.e., when it belongs to the same class (normal area) as the training data, a “+1” is returned; when a<0, i.e., when it does not belong to the same class as the training data, a “−1” is returned. Also, sₛᵥ corresponds to an αᵢ, where 0<aᵢ<1/(vl). l is the total number of training data. Note that in actuality the majority of αᵢ are 0, the only values which play an important role for discrimination are the non-zero αᵢ and training data (support vectors) xᵢ corresponding to those.

In FIG. 3 we schematically show a 1 class SVM method mapping space. FIG. 3 shows a 2D workpiece based on two parameters (data 1 and data 2). Four normal areas C are contained in this mapping space.

Note that when utilizing the Mahalanobis distance, the single large ellipse containing the four normal areas C of this mapping space is the unit space. Therefore the non-normal areas between the four normal areas C end up being contained in the unit space. In response to this, by using the 1 class SVM method, an accurate normal area can be defined even if, as shown in FIG. 3, normal area C is divided into multiple locations.

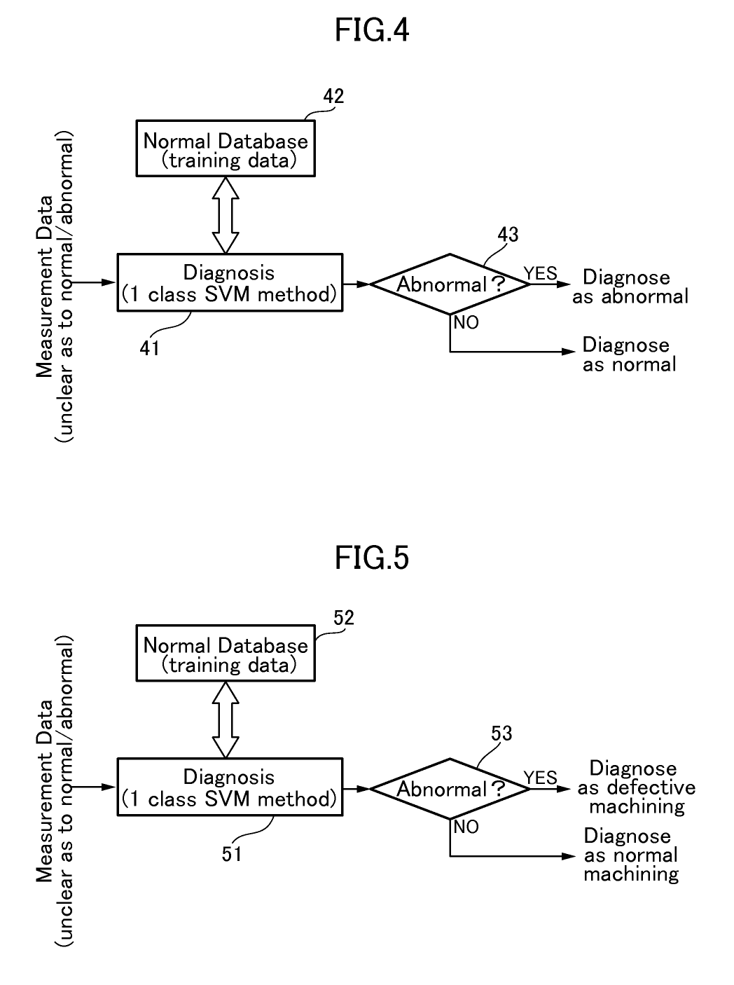

Once class SVM method mapping space information (training data) generated by normal areas C through training are stored in a normal database (38 in FIG. 1; 42 in FIG. 4).

After machine tool 10 has been shipped and begun to be used, re-measurement data is acquired by measuring multiple parameters of machine tool 10 as it is again operated in predetermined operating patterns. Here, as at time of shipment, the machine tool is operated in the operating pattern shown in FIG. 2, Measurement data for the same parameters is then acquired by the various sensors.

Next, referring to FIG. 4, we explain a machine tool diagnostic step using diagnostic unit 41. Note that in the present embodiment the training unit and diagnostic unit of the invention can be implemented by a computer.

When diagnosing, the re-measured data is used as test data. A determination is then made as to whether or not the test data (re-measured data) is contained in the normal area C (see FIG. 3) in the 1 class support vector machine method mapping space stored in normal database 42. Specifically, test data is input to the aforementioned SVM discriminator and a value (f(x)) for the diagnostic result is computed.

A diagnosis of the machine tool is performed based on the diagnostic result (f(x)) (block 43). If the diagnostic result value (f(x)) is non-negative (f(x))≧0), that test data is of the same pattern type as the training data; i.e., it is contained in the normal area. In that case (a “No” in block 43), the machine tool is diagnosed as normal.

On the other hand, if the diagnostic result value (f(x)) is negative (f(x))<0), that test data is of a different pattern type from the training data; i.e., it is not contained in the normal area. In that case (a “Yes” in block 43), the machine tool is diagnosed as abnormal.

Thus in the present embodiment, initial measurement data for predetermined operating pattern[s] is used as training data, and re-measured data for the same operating pattern[s] is used as test data. Thus a high accuracy diagnosis of a normal/abnormal machine tool state can be performed using the 1 class SVM method.

Next, referring to FIG. 5, we explain a second embodiment.

In the second embodiment, an operating pattern for machining mass produced workpieces such as screws or gears is adopted as the operating pattern at the time when machine tool training data and test data are acquired. Therefore in the second embodiment a mapping space normal area is generated in normal database 52, based on training data acquired during operation in a mass-production workpiece machining operation pattern.

In normal database 52, 1 class SVM method mapping space information, in which normal area C has been generated by training when machining a mass produced machined product, is stored in normal database 38.

In the second embodiment, the test data also employs the same operating pattern used at the time of machining mass produced workpieces. In the same manner as the first embodiment, test data is input into the SVM discriminator and a diagnostic result (f(x)) value is computed by diagnostic unit 51.

A diagnosis of the machine tool is performed based on the value of diagnostic result (f(x)) (block 53). In the second embodiment, if the diagnostic result value (f(x)) is non-negative (f(x))≧0), that test data is of the same pattern type as the training data; i.e., it is contained in the normal area. In that case (a No in block 53), machining of the workpiece by the machine tool is diagnosed as normal machining.

On the other hand, if the diagnostic result value (f(x)) is negative (f(x))<0), that test data is of a different pattern type from the training data; i.e., it is not contained in the normal area. In that case a “Yes” in block 53), machining of the workpiece by the machine tool is diagnosed as defective machining.

Thus by generating, as training data, a normal area in a 1 class SVM method mapping space using initial measurement data, measured while operating the machine tool under the operating pattern[s] used when machining a workpiece, data re-measured when the machine tool is actually machining a workpiece can be utilized as test data. If there is an abnormality in the machine tool at that point, the machining precision of the workpieces machined by the machine tool will decrease, degrading the quality of workpieces. Therefore a go/no go diagnosis of the machining of a workpiece can be made based on data from operating patterns at the time of machining. In addition, a quality check of workpieces machined by that machine tool can be indirectly performed by performing a go/no go diagnosis.

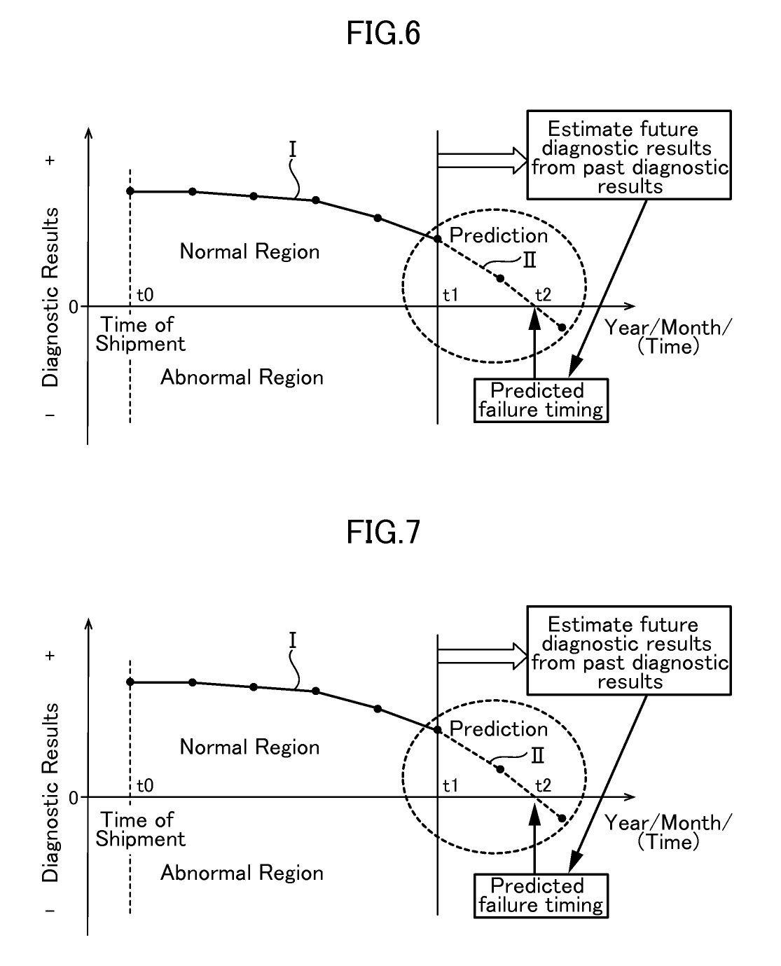

Next, referring to FIG. 6, we explain a third embodiment.

FIG. 6 is an explanatory diagram of a failure timing prediction based on diagnostic results; the horizontal axᵢ s shows time and the vertical axᵢ s shows SVM discriminator diagnostic result (f(x)) values. These diagnostic result (f(x)) value correspond to the position of test data in the mapping space, such as that shown in FIG. 3. The more the diagnostic result (f(x)) value approaches zero from a positive value, the more the test data position approaches, from inside normal area C in FIG. 3, the boundary line between normal area C and the abnormal area. When the training data (f(x)) value is zero, the test data is positioned on the boundary line. Moreover, if the value of training data (f(x)) is negative, the test data is position outside normal area C.

The FIG. 6 curve I connects with solid lines a plot of the diagnostic results (f(x)) when multiple iterations of test data are input to an SVM discriminator from machine tool shipment time t0 until current time t1. As shown by curve I, the plot is contained in the diagnostic result (f(x))>0 normal area until present time t1.

Note that the test data acquisition interval can be set at will, and may be a fixed interval or an irregular interval.

However, each plot value is on a declining trend with the passage of time, and when this trend is extended, as shown by dotted line II the diagnostic result (f(x)) value at time t2 is predicted to be 0.

Note that an extrapolation method based on curve I or other desired method may be employed for prediction.

Thus by using time-related shifts in diagnostic results, the timing of test data deviation from the normal area C can be predicted as the timing for a machine tool failure. In this case, time t2 is predicted as the machine tool failure timing. It can therefore be seen that measures such as maintenance checks or the like must be implemented prior to time t2.

Next, referring to FIG. 7, we explain a third embodiment. FIG. 7 is an explanatory diagram of failure timing prediction based on diagnostic results; the horizontal axᵢ s shows time and the vertical ax, s shows SVM discriminator diagnostic result (f(x)) values. The FIG. 7 curve I connects with solid lines plots of diagnostic results (f(x)) when multiple iterations of test data are input to an SVM discriminator from machine tool shipment time t0 until current time t1. As shown by curve I, the plot points are contained in the diagnostic result (f(x))>0 until present time t1.

However, each plot value is on a declining trend with the passage of time, and extending this trend, as shown by dotted line predicts the diagnostic result (f(x)) value at time t2 will be 0.

Thus based on time shifts in diagnostic results, the timing for a deviation of test data from the normal area can be predicted as the replacement timing for consumable parts installed on the machine tool, such as bites or other cutting tools, or sharpening stones, etc. In this case time t2 is anticipated as the consumable part replacement timing, i.e., as the lifespan of consumable parts. It can therefore be seen that consumable parts must be replaced prior to time t2.

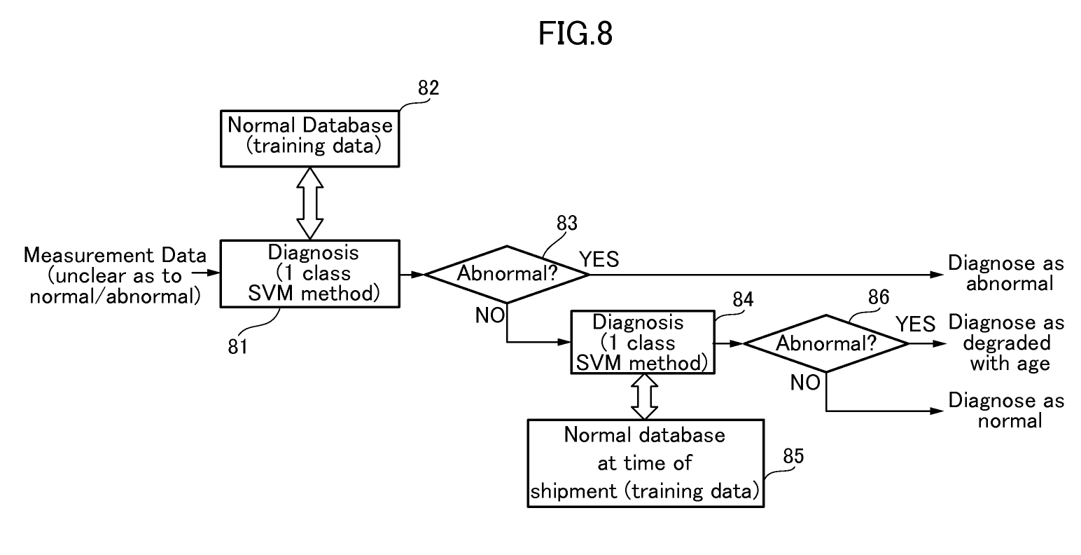

Next, referring to FIG. 8, we explain a fifth embodiment.

In the FIG. 5 embodiment, test data is used as additional training data to generate a new normal area in a new mapping space of the 1 class support vector machine method. Information for the 1 class SVM method mapping space in which this new normal area is generated is stored in the latest normal database 82.

Note that updating of this latest database 82 by the addition of training data can be done regularly or irregularly.

Also, initial training information based on training data at time of shipment is left in the time-of-shipment normal database 85.

When diagnosing, a determination is first made based on training data stored in the latest database 82 of whether or not test data is contained in normal area C in the 1 class support vector machine method mapping space. Specifically, as in the first embodiment, test data is input to the updated SVM discriminator to calculate a value for diagnostic result (f(x)) (block 81).

Then, based on the diagnostic result (f(x)) value, which is based on the latest normal database 82, a machine tool diagnosis is performed (block 83). If the diagnostic result value (f(x)) is negative (f(x))<0), that test data is of a different pattern type from the training data; i.e., it is not contained in the normal area. In that case (a “Yes” in block 83), the machine tool is diagnosed as abnormal.

On the other hand, when the value of the diagnostic result (f(x)) based on latest normal database 82 is non-negative ((f(x)≧0) (a “No” in block 83), a determination is now made, based on the training data stored in time-of-shipment normal database 85, as to whether or not test data is contained in the normal area in the 1 class support vector machine method mapping space. Specifically, as in the first embodiment, test data is input to the initial SVM discriminator to compute a value for diagnostic result (f(x)) (block 84).

Then, based on the diagnostic result (f(x)) value, which is based on the time-of-shipment normal database 85, a machine tool diagnosis is performed (block 86). If the diagnostic result value (f(x)) is negative (f(x))<0), that test data is of a different pattern type from the initial training data; i.e., it is not contained in the initial normal area C. In that case (a “Yes” in block 86), test data is not contained in the initial normal area, but is contained in the updated normal area. In this case the machine tool is diagnosed as having degraded with age.

On the other hand if the diagnostic result value (f(x)) is positive ((n))>0), that test data is of the same pattern type as the initial training data; i.e., it is contained in the normal area. In that case (a “No” in block 86), test data is contained in both time-of-shipment normal area C and the updated normal area. In this case the machine tool is diagnosed as normal.

Decreases in diagnostic accuracy can be prevented by updating the 1 class SVM method mapping space normal area using test data as additional training data to prevent a decrease in diagnostic accuracy caused by aging-related changes in the machine tool.

In the above-described embodiments we explained the invention relative to examples configured for specific conditions, but the invention can be variously modified and combined, and is not limited thereto. For example, in the above-described embodiments we explained examples in which a diagnosis is performed by collecting data about the entire machine tool including both the feed system including servo motor, and the main motor, but the invention can, for example, also perform diagnoses by acquiring data targeted only at the machine tool feed system, or only at the main motor.

What is claimed is:

1. A machine tool diagnostic method comprising:
an initial acquisition step for acquiring initial measurement data by measuring multiple parameters of the machine tool while operating the machine tool in a predetermined operating pattern;
a generating step for generating a normal area in a mapping space of a 1 class support vector machine method using the initial measurement data as training data;
a reacquisition step in which, after operating the machine tool, the multiple parameters are measured to acquire re-measured data while again operating the machine tool in the predetermined operating pattern; and
a diagnostic step for diagnosing the machine tool using the re-measured data as test data, based on whether or not the test data is contained in the normal area of the mapping space in the 1 class support vector machine method.

2. The machine tool diagnostic method according to claim 1,
wherein the diagnostic step diagnoses the machine tool as normal when the test data is contained in the normal area, and diagnoses the machine tool as abnormal when the test data is not contained in the normal area.

3. The machine tool diagnostic method according to claim 1,
wherein the predetermined operating pattern is an operating pattern in which the machine tool machines a workpiece, and
wherein the diagnostic step diagnoses the machining of the workpiece by the machine tool as normal machining when the test data is contained in the normal area, and diagnoses the machining of the workpiece by the machine tool as defective machining when the test data is not contained in the normal area.

4. The machine tool diagnostic method according to claim 1,
wherein the reacquisition step is performed multiple times at different periods, and
wherein the diagnosis step predicts timing of a deviation in test data from the normal area as timing of a machine tool failure occurrence, based on changes over time in the position of the test data in the mapping space.

5. The machine tool diagnostic method according to claim 1,
wherein the reacquisition step is performed multiple times at different periods, and
wherein the diagnosis step predicts timing of a deviation in test data from the normal area as timing for replacing consumable parts built into the machine tool, based on changes over time in the position of the test data in the mapping space.

6. The machine tool diagnostic method according to claim 1, further including a step in which the test data is used as additional training data to generate a new normal area in a new mapping space of the 1 class support vector machine method,
wherein the diagnostic step diagnoses that the machine tool is abnormal when the test data is not contained in the new normal area,
wherein, even when the test data is contained in the new normal area, the diagnostic step diagnoses that the machine tool is degraded by aging when the test data is not contained in the initial normal area, and
wherein the diagnostic step diagnoses that the machine tool is normal when the test data is contained in both the new normal area and the initial normal area.

7. A machine tool diagnostic system comprising:
a measurement unit for outputting initial measurement data by measuring multiple parameters of the machine tool while operating the machine tool in a predetermined operating pattern, wherein, after the operation of the machine tool, the measurement unit outputs re-measured data by measuring the multiple parameters of the machine tool while operating the machine tool in the predetermined operating pattern again;
a training unit for generating a normal area in a mapping space of a 1 class support vector machine method using the initial measurement data as training data;
a storage unit for storing the normal area in the mapping space; and
a diagnostic unit for diagnosing the machine tool based on whether or not the test data is contained in the normal area in the mapping space of the 1 class support vector machine method, by using the re-measured data as test data.

8. The machine tool diagnostic system according to claim 7,
wherein the diagnostic unit diagnoses the machine tool as normal when the test data is contained in the normal area, and diagnoses the machine tool as abnormal when the test data is not contained in the normal area.

9. The machine tool diagnostic system according to claim 7,
wherein the predetermined operating pattern is an operating pattern in which the machine tool machines a workpiece,
wherein the diagnostic unit diagnoses the machining of the workpiece by the machine tool as normal machining when the test data is contained in the normal area, and diagnoses the machining of the workpiece by the machine tool as defective machining when the test data is not contained in the normal area.

10. The machine tool diagnostic system according to claim 7,
wherein the measurement unit makes multiple measurements of the re-measured data at different times, and
wherein the diagnosis unit predicts timing of a deviation in test data from the normal area as timing of a machine tool failure occurrence, based on changes over time in the position of the test data in the mapping space.

11. The machine tool diagnostic system according to claim 7,
wherein the measurement unit makes multiple measurements of the re-measured data at different times, and
wherein the diagnosis unit predicts timing of a deviation in test data from the normal area as timing for replacement of consumable parts built into the machine tool, based on changes over time in the position of the test data in the mapping space.

12. The machine tool diagnostic system according to claim 7,
wherein the training unit uses the test data as additional training data to generate a new normal area in a new mapping space in the 1 class support vector machine method,
wherein the storage unit stores the new normal area in the mapping space,
wherein the diagnostic unit diagnoses that the machine tool is abnormal when the test data is not contained in the new normal area,
wherein, even when the test data is contained in the new normal area, the diagnostic unit diagnoses that the machine tool is degraded by aging when the test data is not contained in the initial normal area, and
wherein the diagnostic unit diagnoses that the machine tool is normal when the test data is contained in both the new normal area and the initial normal area.
